(19) United States
(12) Patent Application Publication
(10) Pub. No.: US 2008/0314272 A1
(43) Pub. Date: Dec. 25, 2008

(54) Printing method and apparatus

(75) Inventors: Gil Rosenman, Rishon Le-Zion (IL); Daniel Aronov, Kfar Yona (IL)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Ramot at Tel-Aviv University Ltd., Tel-Aviv (IL)

(21) Appl. No.: 12/150,937

(22) Filed: May 1, 2008

Related U.S. Application Data
(63) Continuation-in-part of application No. 12/148,824, filed on Apr. 23, 2008.
Application No. 12/148,824 is a continuation-in-part of application No. PCT/IL2006/001231, filed on Oct. 26, 2006.
(60) Provisional application No. 60/730,021, filed on Oct. 26, 2005.

(51) Int. Cl. B41N 3/00

(52) U.S. Cl. 101/463.1

(57) ABSTRACT

Disclosed are a printing method and apparatus which utilizes surface modification of a substrate on which an indicia pattern is to be created.

### CROSS-REFERENCE TO RELATED APPLICATIONS

This present application is a continuation-in-part of U.S. patent application Ser. No. 12/148,824, which was filed on Apr. 23, 2008, which is a continuation-in-part of International Application No. PCT/IL2006/001231, which was filed on Oct. 26, 2006, published in English, which claims the benefit of U.S. Provisional Patent Application 60/730,021, filed on Oct. 26, 2005. The disclosures of said applications are incorporated by reference herein.

### FIELD OF THE INVENTION

This invention relates to a method and a device for printing patterns on a substrate.

### BACKGROUND OF THE INVENTION

Printing techniques are generally of two types, the so called “offset” printing (lithography) and a direct writing. The present invention generally relates to the offset printing technology.

In the offset lithography, which depends on photographic processes, flexible aluminum or plastic printing plates are used. Modern printing plates have a brushed or roughened texture and are covered with emulsion of the kind sensitive to an electromagnetic radiation. Materials used as emulsions are typically organic materials such as oligomers, silicone, polymers, etc possessing low surface energy. A desired image is placed in contact with the emulsion and the plate is exposed to an electromagnetic radiation at specific wavelength. After development procedure using chemical treatment, the emulsion shows a reverse of the negative/positive image, which is thus a duplicate of the original (positive/negative) image. The image on the plate emulsion can also be created through direct laser imaging in a CTP (Computer-To-Plate) device called a platesetter. The positive image is the emulsion that remains after imaging.

### GENERAL DESCRIPTION

There is a need in the art to simplify the offset printing technology by avoiding the use of any chemicals at any stage of the printing plates preparation, image patterns recording and plates renovation, as well as reducing number of the technological steps, and enabling to reach a higher printing resolution.

The present invention provides a novel printing method and apparatus which utilizes surface modification of a substrate (plate) on which an indicia pattern is to be created. To this end, the invention utilizes irradiation of the substrate's surface with a low energy electron beam and possibly in combination with electromagnetic radiation to modulate the surface properties of a solid substrate (local surface modification, or first entire and then local modification) in a controllable manner, and, if needed, reversible manner.

The inventors have found that the surface property (e.g. wettability, affinity, etc.) of a material can be changed by inducing and/or varying a surface energy of material, and this without inducing or modifying any volumetric effects of the material such as defect structure, as well as phase state of materials. Such variation of the surface property is carried out by applying a low energy electron beam to the surface region of a substrate to thereby convert this region from an initial hydrophilic state into a hydrophobic state. In this connection, the following should be noted:

Surface wettability is a paramount property of solid surfaces. The pioneering analysis of wettability has been presented by Young (Young, T. Philosophical Transactions R. Society, London, 95:65 (1805)) who considered the equilibrium state between forces acting on the contact line separating wetted and unwetted portions of a homogenous smooth solid surface. Young showed that the contact angle between deposited liquid droplet and material surface depended on energies associated with interfacial surface-liquid, surface-vapor and vapor-liquid and represented a complex fundamental property of solid materials and which could allow studying intermolecular interactions on the surface.

Hydrophilicity is a characteristic of materials exhibiting an affinity for water. These materials, when wetted, form a water film or coating on their surface. Hydrophilic materials demonstrate a low contact angle value (the angle between water drop and solid state surfaces, (FIG. 1)). Hydrophobic materials on the other hand, possess the opposite response to water. Hydrophobic materials have little or no tendency to adsorb water and water tends to “bead” on their surfaces (i.e., discrete droplets). Hydrophobic materials possess high contact angle values.

Wettability is a surface property characteristic for all materials, which is unique for each material. The wettability may be determined by one of many methods known to a person skilled in the art, such as liquid droplet contact angle measurements, the captive bubble method, or by complete surface energy analysis. Contact angle is an important macroscopic characteristic of the surface wettability and the interfacial free energy. There are several techniques available for contact angle measurements. The pendent and sessile drop methods are among the most generally used experimental techniques. When a drop of liquid is deposited on the surface of a dense material, the spreading of this drop depends mainly on the surface chemistry as well as on surface topography. At equilibrium, the drop exhibits a spherical shape as shown in FIG. 1; the angle between the solid surface and the tangent to the liquid in contact with the solid is known as the contact angleθ. The contact angle is related to interfacial energies (α) between the different phases by the Young equation (Eq. 1):

αₛᵥ=αₛₗ+αₗᵥ cos θ (Eq. 1)

where subscripts ‘s’,‘l’ and ‘v’ refer to solid, liquid and vapor, respectively. The only parameters that can be directly measured are θ and αₗᵥ. Thus, to directly determine the two solid surface tensions αₛₗ and αₛᵥ, individually, an additional equation is required. Many controversial approaches are reported in the literature to evaluate solid surface tension. Owen and Wendt's approach (Owens D. K, Wendt R. D. J. Appl. Polym. Sci. 13, 1741 (1969)) is based on the assumption that the total surface tension can be expressed as a sum of two components, α^{p} and α^{d}, which arise owing to a specific type of intermolecular force, polar (α^{p}) and disperse (α^{d}) components, respectively. The dispersive component is defined as twice the geometric mean of the dispersive components of the surface energy of solid and liquid, and can be calculated from Eq. 2 :

αₛₗ=αₛᵥ+αₗᵥ−2\sqrt{αₛᵥ^{p}αₛₗ^{p}}−2\sqrt{αₛᵥ^{d}αₛₗ^{d}} (Eq. 2)

From the Eq. 1 and 2, αₛₗ and αₛᵥ can be determined using experimental values of contact angles measured with a pair of testing liquids of known dispersive and polar surface tension components. The work of adhesion (W) is the energy required to separate to infinity the materials in contact, then defined by the Young-Dupré's equation, in the case of a solid/liquid (sl) interface, as:

W=αₛ+αₗ−αₛₗ=αₗᵥ(1+cos θ) (Eq. 3)

where subscripts ‘s’ and ‘l’ refer to solid and liquid respectively.

The considered basics of interaction of solid state surface with liquid show that many factors of different physical origin influence the surface wettability due to changes of a surface energy of the material and interaction of liquid-substrate.

The major trends in modern microelectronic, optical, chemical, pharmacological, and other material-based processing technologies are based on the development of smart substrates with modified physico-chemical interfaces which permit variation of their fundamental surface properties such as affinity to atomic/molecule adsorption and adhesion, chemical etching intensity, catalytic chemical activity, metal and dielectric layers deposition, hygroscopic ability, encapsulation, agglomeration, bonding, friction, flotation, etc. The developed technologies employ such diverse methods which bring about changes in the chemical identity, topographic features, charge state of the substrates by means of intermediate layers of different chemical origin, nanostructuring, tailoring of electret state. All these methods modify the free energy of the original surface of the substrates and subsequently several of its related key technological properties such as adsorption, adhesion, etching, bonding, friction, catalytic activity, biocompatibility, wettability, hygroscopicity, encapsulation, agglomeration, etc.

Modification of surface free energy and related properties of the solid materials suitable for material science-oriented technologies and biomedical applications presents the possibility of combining the ideal bulk properties (e.g. tensile strength or stiffness, electronic or optical properties) with the desired surface properties (e.g. adhesion, adsorption, wettability, selectivity to chemical interaction with particular molecules and biocells, biocompatibility, encapsulation, agglomeration, friction, etc). One of the appropriated and efficient ways to study and calculate the surface free energy involves surface wettability analysis.

In the literature, various different approaches are mentioned which make it possible to evaluate the solid surface energy, using measured contact angles by liquids with known or pre-characterized surface energy parameters. In other words, a variation of the wettability is a variation of the surface energy.

As indicated above, the present invention utilizes modification of properties related to a surface energy of a solid state surface without inducing or modifying any volumetric effects of the material such as defect structure, phase state of materials, etc.

The invention allows for inducing and/or varying a surface property of the material by a low-energy electron irradiation, and/or by combination of the later with electromagnetic radiation. As a result, the method can provide switching or gradual tuning of surface properties, such as wettability, adhesion, adsorption, hygroscopicity. The induced variation of the surface properties can be totally reversed by applying electromagnetic radiation to the previously electron-modified surface (electron irradiated and/or electron-and-light irradiated).

The parameters of the electron irradiation, such as direction of electron beam propagation, current density of electron beam, electron energy, and/or duration (doze) of the irradiation, and possibly also parameters of the electromagnetic radiation (e.g. wavelength, intensity, polarization, and/or profile (time variation and duration)), are co-adapted to each material (and optionally to the effect to be achieved), so that the majority of the incident particles (electron and/or electron and photon) are absorbed in the surface layer. By this, the electron (hole) occupation of bulk traps and surface states as well as surface states and their occupation are modified resulting in variation of surface potential and surface energy without generating or modifying volumetric properties (the defect structure and phase state of the material).

The invention provides a method and apparatus for use in printing of an indicia pattern on a surface of a solid substrate (constituting a first solid material). This is implemented by irradiating the surface of a substrate at least by an electron beam and controlling at least one parameter of the irradiation, in accordance with the characteristics of the substrate material, in order to appropriately modify a surface property of the substrate in connection with its affinity towards a certain second material in selected surface regions of the substrate (defined by the indicia pattern). The parameter(s) is(are) controlled such as to maintain structural and phase state properties of the substrate material. The so created pattern of the surface property of the substrate enables deposition of the second material thereon, either onto selected regions or onto spaces between them, resulting in the printed indicia pattern.

It should be understood that the invention provides creation of a surface property pattern on the substrate, enabling selective attachment of a foreign (second) material to the patterned substrate, i.e. allows attachment of the second material to modified regions of the substrate (while in the initial, non-modified state of the substrate such attachment cannot be achieved), or prevents attachment of the second material to the modified regions.

In some embodiments of the invention, the creation of the surface property pattern of the substrate is a single-stage process: the electron beam irradiation is directly applied to the selected regions of the substrate. This can be implemented by scanning, by using a mask, or by using micro-columns with an array of electron emission devices, e.g. utilizing nanotube-based electron emission device, e.g. as described in WO 01/84130. The applied electron beam irradiation converts the substrate material within the irradiated regions from initial hydrophilic state into hydrophobic state.

In some other embodiments of the invention, the creation of the surface property pattern of the substrate is a two-stage process: Electron irradiation is applied to the entire surface area in which the pattern is to be created, this being a preparation stage during which the entire surface area is converted from initial hydrophilic state into hydrophobic state. Then, the actual patterning stage (image pattern recording) is performed consisting in applying electromagnetic radiation of a specific wavelength range to the selected regions of said area (in accordance with the indicia pattern).

Upon creating a pattern of the surface property on the substrate (first material), another second material is deposited being attachable to either the previously irradiated regions or spaces between them. Thus, the indicia pattern, in the form of spaced-apart regions of the second material spaced by regions of the first material (that of the substrate), is created.

It should be understood that the minimal dimension of a modified surface feature, or in other words the resolution of patterning achievable by the technique of the present invention, is defined by a cross-sectional dimension (diameter) of the electron beam (single-stage patterning process) or of the electromagnetic radiation beam (two-stage patterning process), and can thus be in the nanometer scale with the existing technologies in this field.

There is, thus, provided according to one broad aspect of the invention, a method for use in printing of an indicia pattern on a surface of a first solid material, the method comprising irradiating said surface at least by an electron beam and controlling at least one parameter of said irradiation, in accordance with characteristics of said first material, in order to modify a surface property of the first material in connection with its affinity towards a certain second material in selected regions of the first material defined by the indicia pattern to be printed, while maintaining structural and phase state properties of the first material, thereby enabling deposition of the second material onto the first material such that said second material can be attached either to the selected regions or to the spaces between them on said surface of the first material, resulting in the printed indicia pattern.

As indicated above, the electron beam is a low energy beam, typically the energy substantially not exceeding 1000 eV.

Modifying of the surface property of the material within said at least region thereof may comprise switching or gradual tuning of at least one of affinity, wettability, adhesion, adsorption, hygroscopicity, bonding, friction, encapsulation, and agglomeration, etc.

As indicated above, the modification of the property(s) of the material does not substantially induce or further modify any defect structure or the phase state of the material.

The controllable parameters in case of electron beam irradiation include at least one of current density, energy and duration of the applied charged particles' (electron) beam irradiation and in case of the electromagnetic radiation may alternatively or additionally include its intensity, wavelength and direction of propagation.

The second material may be at least one of the following: a printable ink, dye, pigment; metal, dielectric, semiconductor, fluorescent material, biomaterial, polymer, or any other material of various origin and dimension including nanoparticles.

The second material may be of optical properties different from that of the first material. In this case, the first material substrate with the indicia pattern thereon may be used as a phototool (reticle) for use in a lithography tools arrangement.

It should be emphasized that the application of electron irradiation and/or electron and electromagnetic radiation allows creating a pattern in the form of spaced-apart regions, of any shape and/or size, of the modified surface property, without causing any material removal in said regions and spaces between them.

The present invention can advantageously be used in various printing techniques, e.g. for printing ink onto a support substrate.

According to yet another broad aspect of the invention, there is provided a patterning device for creating an indicia pattern on a surface of a first solid material, the device comprising an irradiation system configured and operable for irradiating selected regions of the first material defined by the pattern to be printed, the irradiation system comprising at least an electron beam source configured and operable to generate a low energy electron beam; and a control unit for operating said irradiation system to control at least one parameter of at least said electron beam in accordance with said first material in connection with its affinity towards a certain second material to be printed on the first material so as to induce or vary a surface potential and/or surface energy of the first material by said irradiation while maintaining structural and phase state properties of the first material, thereby enabling deposition of the second material onto the surface of the first material within either the selected regions or spaces between them.

The irradiation system may also include electromagnetic radiation source, to be applied to the selected regions of the material, after the irradiation by the low energy electron beam.

According to yet further aspect of the invention, there is provided a solid substrate having a surface property pattern, said pattern being in the form of varying affinity of the substrate towards a certain foreign material. The pattern may be in the form of regions of one affinity towards the foreign material spaced by regions of another different affinity towards said foreign material.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a schematic representation of the conventional sessile drop method used to determine surface energy by wettability.

FIG. 2 is a block diagram of a lithography tools arrangement utilizing a patterning device according to the invention;

FIG. 3A illustrates one example of the configuration and operation of the lithography tools arrangement utilizing a patterning device of the invention;

FIG. 3B illustrates another example of the configuration and operation of the lithography tools arrangement utilizing a patterning device of the invention;

FIG. 4a-4c show each the side and top views of the static water contact angles on post anodized treated aluminum printing plates, where FIG. 4a corresponds to post anodized treated (PAT) Aluminum(Al) printing plate sample, FIG. 4b corresponds to electron irradiated PAT Al-sample, and FIG. 4c corresponds to electron irradiated PAT Al-sample followed by light illumination;

FIG. 5 illustrates PAT Al printing plate after the two-stage patterning applied thereto;

FIG. 6 illustrates high-resolution patterning of PAT Al printing plate, performed by a low energy electron irradiation via shadow mask;

FIG. 7 illustrates two-stage high-resolution patterning of PAT Al printing plate and ink deposition thereon;

FIGS. 8a and 8b illustrate electron-induced high-resolution water/ink patterning on PAT Al (FIG. 8a) and anodized with no PAT Al printing plates (FIG. 8b) performed by a low energy electron irradiation via shadow mask.

FIG. 9 demonstrate tunable hydrophobicity of a SiO₂ substrate, without chemical or mechanical treatments of the surface (the three pictures labeled a-c at different angles).

FIGS. 10A to -10C shows the various channel structures formed on a Si-substrate: FIG. 10A shows micro-channel structures; FIG. 10B shows water matrix; FIG. 10C shows open-air water microchannels.

FIG. 11 shows a patterned substrate obtained from deposition of Co metal on a modified Si-substarte.

FIG. 12 shows the structured crystallization of Na₂CO₃ on a Si-substarte.

FIGS. 13A and 13B demonstrate a micropatterned surfaces such as isolated water (liquid) matrices (FIG. 13A) and water microchannels (FIG. 13B) on silicon oxide surfaces.

FIG. 14 demonstrates the result of electron beam charging of glass material.

FIG. 15 demonstrates the result of electron beam charging of Ti, Ag, and Al₂O₃ surfaces.

FIG. 16 shows before and after electron beam charging of paper.

FIG. 17 demonstrates a patterning on SiO₂ surface using combination of electron irradiation and electromagnetic radiation (light illumination).

FIG. 18 shows a schematic representation of preliminary patterned by electron beam substrates.

FIGS. 19A and 19B show aluminum metal vacuum sputtering on Si substrate: FIG. 19A—after electron irradiation (no Al adhesion) and FIG. 19B—untreated one demonstrating excellent Al adhesion.

### DETAILED DESCRIPTION OF EXEMPLARY EMBODIMENTS

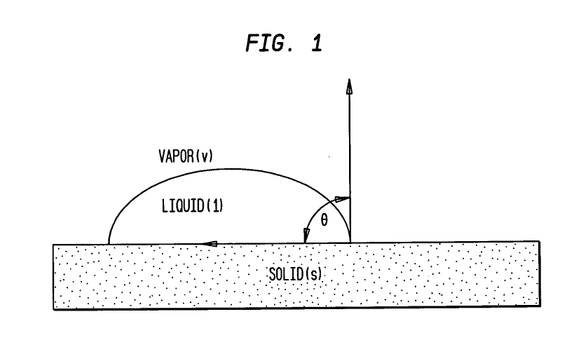

FIG. 1 is related to the background of the invention.

To facilitate understanding, the same reference numbers are used for identifying components that are common in all the examples of the invention.

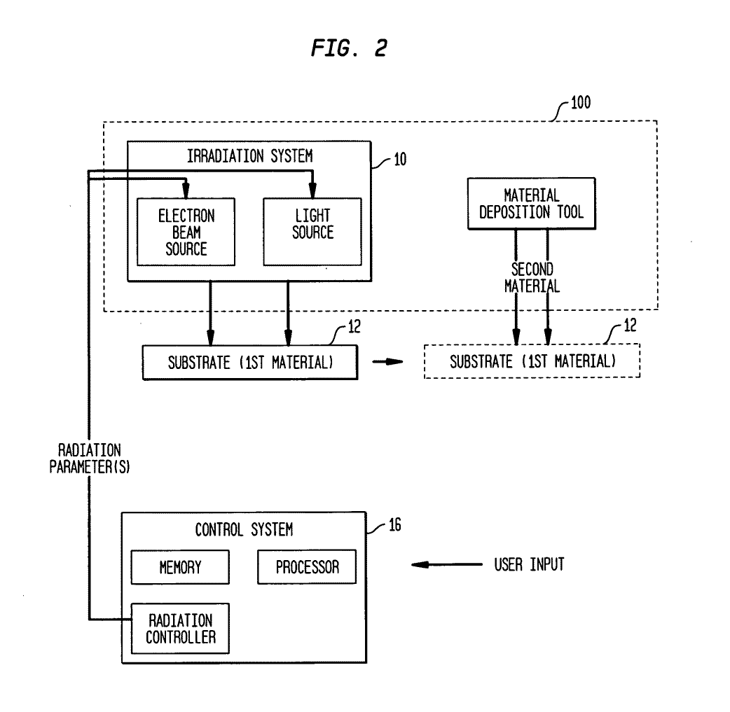

Referring to FIG. 2, there is illustrated, by way of a block diagram, a lithography tools arrangement 200 utilizing a patterning device 10 according to the invention and a material deposition tool 11. The patterning device 10 includes an irradiation system 14 associated with a control system 16. Irradiation system 14 includes an electron beam source 14A and possibly also an electromagnetic field source (light source) 14B. Irradiation system 14 is configured and operable by control system 16 for irradiating at least selected surface regions of a first material substrate 12 by a low energy electron beam (and possibly also a light beam as will be exemplified below). The parameters of the electron beam (and possibly also the light beam) are controlled in accordance with the substrate material in connection with its affinity towards a certain second material to be further deposited so as to induce or vary a surface potential and/or surface energy of the substrate within the selected regions while maintaining structural and phase state properties of the substrate material.

The control unit 16 is typically a computer system including inter alia a memory utility, e.g. for storing parameters (e.g. electron structure) of various materials; a processor utility e.g. adapted for considering the material's parameters (e.g. from user input) and an effect to be achieved by deposition for generating control parameters for the irradiation to be applied; and irradiation controller configured to operate the irradiation system accordingly. The control unit 16 may also incorporate a measurement unit (not shown) for controlling the static charge being created (as well as charge being then removed, as the case may be) by carrying out measurements of the charge and/or the surface energy and/or other surface properties.

The irradiation system appropriately operated creates on the substrate a pattern of spaced-apart regions of modified surface property, e.g. a pattern of affinity. When the second material is deposited onto the so-patterned surface of the substrate 12, the second material becomes attached to either the modified regions or the spaced between them, resulting in a desired indicia pattern.

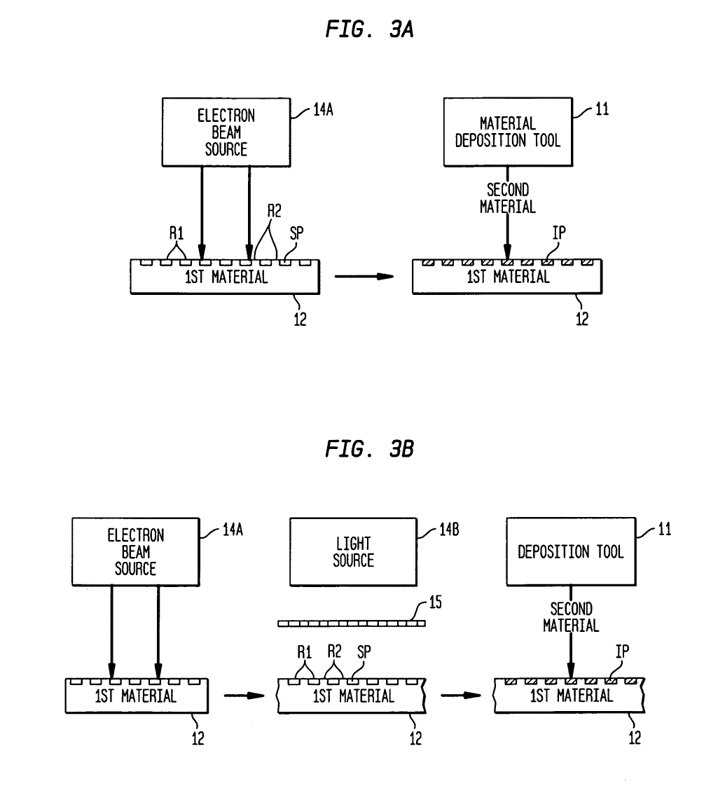

Reference is made to FIGS. 3A and 3B exemplifying two configurations of the above-described lithography tools arrangement.

In the example of FIG. 3A, the creation of the affinity pattern or generally surface property pattern SP is a single-stage process. The irradiation system 14 of the patterning device 10 includes an electron beam source 14 and a control unit 16. In this case, the electron beam source is configured and operable to apply electron beam irradiation of controlled parameter(s) to selected regions of the substrate to directly create the affinity pattern. This can be performed by providing a relative displacement between the electron beam and the substrate (scanning); or using the electron beam source capable of generating a plurality of spatially separated electron beams; or passing the electron beam irradiation through a mask.

The parameters of the electron beam are selected in accordance with the material in use and an effect to be achieved, namely modification of the surface property(s) affecting affinity to wettability, adhesion, adsorption, hygroscopicity, and other related surface energy parameters. Such electron beam parameters include a direction of beam propagation, electron energy, current density and duration (dose). Then, the second material is deposited onto the patterned substrate resulting in the selective attachment of this material to the substrate leading to an indicia pattern IP.

FIG. 3B exemplifies the lithography tools arrangement in which irradiation system of the patterning device includes both the electron beam source 14A and the light source 14B. First, the electron beam is applied to the entire surface of the substrate 12 (or a certain area thereof where the pattern is to be placed). By this, the entire surface of the substrate is modified by converting it from an initial hydrophilic state into a hydrophobic state or vice versa. Then, light is applied e.g. through a mask 15 to the selected regions of the substrate resulting in a pattern SP of spaced-apart hydrophilic regions spaced by hydrophobic ones or vice versa. The light parameters are to be adjusted accordingly, namely wavelength and/or intensity and/or polarization and/or duration (profile). Then, the second material is deposited onto the patterned substrate resulting in the indicia pattern IP due to the selective attachment of this material to the substrate.

It should be understood that the material deposition tool may be of any suitable type, including those allowing chemical or physical deposition as well as those utilizing a dipping bath. In the latter case, the patterned substrate (i.e. with the surface property pattern) may for example be introduced into a compatible reservoir of ink and water mixture, thereby resulting in that the ink adheres to the hydrophobic (e.g. oleophilic) regions creating positive image and the water covers the negative image.

The device 10 is thus configured as a patterning device for creating a surface property (affinity towards another material) pattern, by modifying the surface properties of the selected region to which the irradiation is applied. Moreover, the so-modified surface properties can be reversed, for example by radiating the respective region by electromagnetic radiation with specific wavelength, intensity and duration. It is important to note that the surface properties modifying technique of the present invention does not cause any volumetric changes in the subject material (i.e. creation of defects, change in the phase state of the material, etc.).

As indicated above, the proposed surface properties modification technique of the present invention affects neither the defect structure nor the phase state of the material bulk. As shown in FIGS. 3A and 3B, surface properties pattern SP created on the substrate's surface is in the form of an array (one- or two-dimensional array) of regions R₁ of the modified surface properties (i.e. the irradiated regions) spaced by regions R₂ of non-modified surface properties. The regions R₁ as well as regions R₂ may be of the same or different geometry, depending on the mask or beam shape used in accordance with a desired pattern to be obtained.

The surface properties pattern creation is thus used as a preliminary step before the material deposition, and is aimed at facilitating one or more of a material's wettability, adhesion, adsorption, etc.

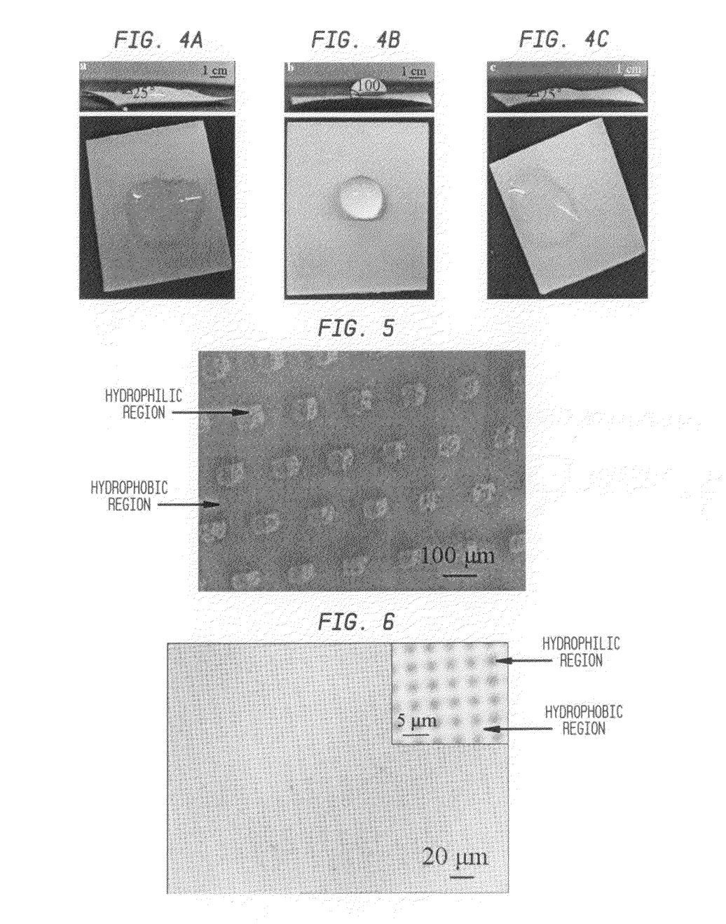

Reference is made to FIGS. 4a-4c showing experimental results. The figures show side and top views of the static water contact angles on post anodized treated aluminum (Al) printing plates. FIG. 4a illustrates post anodized treated (PAT) Al-printing plate sample; FIG. 4b illustrates electron irradiated PAT Al-sample; and FIG. 4c illustrates electron irradiated PAT Al-sample followed by light illumination. The latter was performed using a non-filtered light of 185-2000 nm (Hamamatsu UV spot light source equipped with 200 W Hg-Xe lamp). The electron energy was 350 eV. The incident charge density was 350 μC/cm² (electron current density ˜2 μA/cm², exposition time ˜180 sec.).

These experiments show that post anodized treated (PAT) aluminum printing plate is hydrophilic with static contact angle 25° (FIG. 4a). Low energy electron irradiation leads to a strong variation of the wettability by tailoring on the printing plate pronounced hydrophobic (oleophilic) state with static contact angle of 100° (FIG. 4b). Light illumination of this preliminary electron treated sample returns the illuminated region to the initial hydrophilic state with static contact angle of 25° (FIG. 4c). It should be noted that the same results were obtained on anodized Al plates with no PAT, and on non-anodized Al plates as described below. Thus, it is shown that the method of the present invention utilizing irradiation of a substrate by a low energy electron irradiation combined with an electromagnetic radiation at specific wavelength allows for strongly modifying the surface properties of the post anodized treated Al-printing plate allowing to change it in wide range from hydrophilic to pronounced hydrophobic (oleophilic), without a use of any chemicals. Another valuable property is total reversibility of the modified property which affords renovation of the used Al-printing plates.

FIG. 5 exemplifies the results of the two-stage wettability patterning of PAT Al printing plate (using method described above with reference to FIG. 5B). At the first stage, the plate was irradiated by homogenous electron flux. The electron energy was 350 eV; the incident charge density was 350 μC/cm² (electron current density ˜2 μA/cm², exposition time ˜180 sec.). At the second stage, the so irradiated plate was illuminated by light via a shadow mask using a non-filtered light source with wide optical spectrum 185-2000 nm (Hamamatsu UV spot light source equipped with 200 W Hg-Xe lamp).

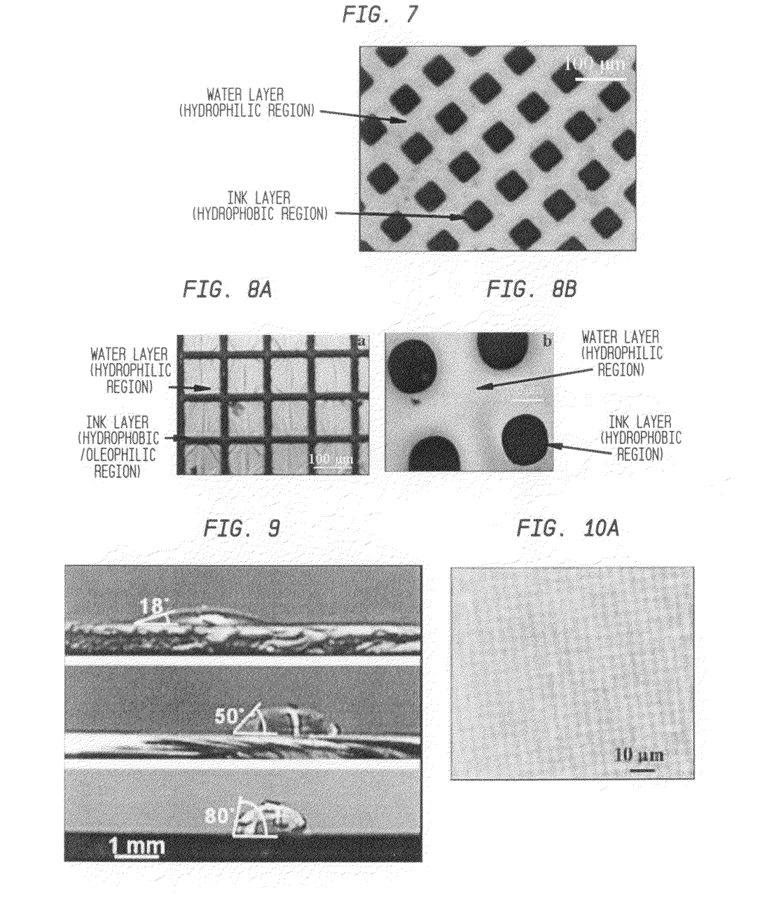

FIG. 6 shows the results of direct electron beam high-resolution affinity patterning of PAT aluminum printing plate (utilizing the method described above with reference to FIG. 3A). The patterning was performed by a low energy electron irradiation via a shadow mask. The electron energy was 350 eV; the incident charge density was 350 μC/cm² (electron current density ˜2 μA/cm², exposition time ˜180 sec.).

FIG. 7 shows yet another example of the two-stage high-resolution water/ink patterning of PAT aluminum printing plate. At the first stage, the plate was irradiated by homogenous low energy electron flux (the electron energy was 350 eV, electron current density ˜2 μA/cm², exposition time ˜180 sec., the incident charge density was 350 μC/cm²). As a result of electron irradiation homogeneous hydrophobic state was created overall the printing plate. At the second stage, the modified surface of the plate was illuminated by light via shadow mask using a non-filtered light source with wide optical spectrum 185-2000 nm (Hamamatsu UV spot light source equipped with 200 W Hg-Xe lamp). Hydrophilic state was fabricated in the illuminated regions while non-illuminated regions stayed hydrophobic (oleophilic). Then, the so-patterned plate was introduced into a bath containing an ink and water mixture, and ink adhered to the hydrophobic regions of the pattern leaving water within the spaces (hydrophilic regions) between them. It should be understood that using other material to be adhered (e.g. other hydrophobic-hydrophilic mixtures) the result may be vice versa.

FIGS. 8A and 8B show the results of the direct electron-induced high-resolution water/ink patterning on a PAT Al (FIG. 8A) and Al printing plates anodized with no PAT (FIG. 8B). Both plates “a” and “b” were irradiated by a low energy electron flux (the electron energy was 350 eV, the incident charge density was 350 μC/cm², electron current density ˜2 A/cm², exposition time ˜180 sec.) via shadow mask. As a result of electron irradiation, hydrophobic (oleophilic) state was created in the irradiated regions of both printing plates. Non-irradiated regions stayed hydrophilic. The figures show that for both plates, introduced to a compatible ink and water mixture, the ink (oil) adhered to the hydrophobic (oleophilic) regions and the water covered the hydrophilic areas. Thus, the pattern of hydrophobic (oleophilic)/hydrophilic features, as well as the stage of the plates preparation (preliminary fabrication of hydrophobic state), were achieved for both PAT and anodized with no PAT (printing plates with no use of chemicals).

Thus, the invented technology of tailoring of needed image patterns provide eliminating a need for chemicals, and provides a faster and cheaper patterning process in comparison to the conventional offset lithography techniques. The invented method also does not cause any damage to environment.

The analysis of physical origin of surface properties shows that properties related to the surface energy of any solid state surface critically depend both on the basic intrinsic physical properties, such as interfacial surface energies-energy interactions of original surface material/liquid, original surface material/vapor, and on the extrinsic properties, which can be varied by using diverse methods of surface modification.

According to the invention, the properties relating to the surface energy are modified by using electron irradiation of the material without generating or modifying bulk and surface defects or phase state of materials. Contrary to the known techniques, the proposed method of the surface modification leading to the wettability or/and other properties related to the surface energy is achieved by applying radiation (electron beam in combination with electromagnetic radiation) to the subjected material.

The method of the invention enables the achievement of tunable wettability (hydrophobicity) of various surfaces such as silicon-based materials in a wide range of contact angles, θ, from 10° to 120°, with accuracy of ±5°. The electron energy was 500 eV, electron current density was 10 nA/cm², exposition time was varied in the range of 0-210 min, and the vacuum conditions were 10⁻⁶ Torr.

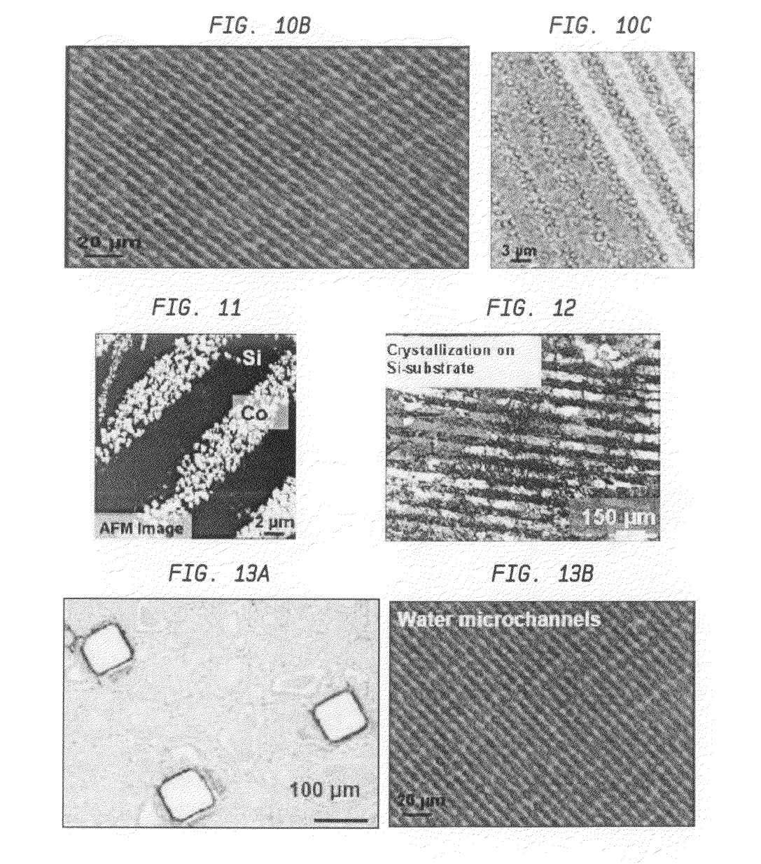

As FIG. 9 demonstrates tunable hydrophobicity of Si substrate, without chemical or mechanical treatments of the surface, was possible. This method (using electron energy of 1000 eV, electron current density of 100 nA/cm², exposition time varied in the range 20 min, and vacuum of 10⁻⁶ Torr) further allowed the fabrication of patterned one-dimensional or two, three-dimensional patterns on the Si surfaces, which could be used as water matrices as shown in FIG. 10A and water microchannels as shown in FIG. 10B, as a patterned substrate for the deposition of different metals, as shown in FIG. 11 for the electroless deposition of Co on the un-irradiated portions of the substrate, or for the crystallization of various materials, as shown in FIG. 12 for the exemplary crystallization of Na₂CO₃ on the unirradiated portions of the Si substrate.

FIG. 10C presents electron-induced patterning of SiO₂ surface with three different levels of wettability providing sharp contrast of wetting. Open-air water microchannels were fabricated on the SiO₂ surface with different degrees of wettability, induced by variation of the incident charge density Q (the incident electron energy is Eₚ=100 eV) . The patterned surface was exposed to a water vapor at a 50% RH. After cooling to a temperature of 5° C. below the dew point, the water condensed on the hydrophilic regions, producing liquid microchannels. Large drops are associated with hydrophilic (untreated) region, whereas dark and bright areas, with no visible drops, are referred to the hydrophobic regions for Q=0.10 and 2 μC/cm², respectively. The tailored microchannels of 3 μm width are homogeneous and shaped as cylinder segments with a constant cross section.

It should be noted that the presented data also indicates that the proposed method allows removing moisture (dewetting effect) and fabricating the patterned surface structure with modulated moisture.

The achievable tunability of hydrophobicity of silicon oxide surface was demonstrated above (FIG. 9) This also allowed fabricating wettability micropatterned surfaces such isolated water (liquid) drops, water (liquid) matrices (FIG. 13A) and water (liquid) microchannels (FIG. 13B) on silicon oxide surfaces.

Other amorphous materials such as silicon nitride, silica, fused silica, etc and dielectric crystalline materials such as Al₂O₃, and mica, which were subjected to the electron beam irradiation showed similar wettability modification. The irradiation conditions were adapted to each material when the electron energy was varied in a range of Eₚ=10-1000 eV, electron current density was about Jₚ=10-300 nA/cm², exposition time was varied in the range of t=0-210 min, and vacuum was 10⁻⁶ Torr. The adaptation means that low energy electron irradiation does not lead to any damage, creation of defects, chemical decomposition, phase state of the material, as described herein.

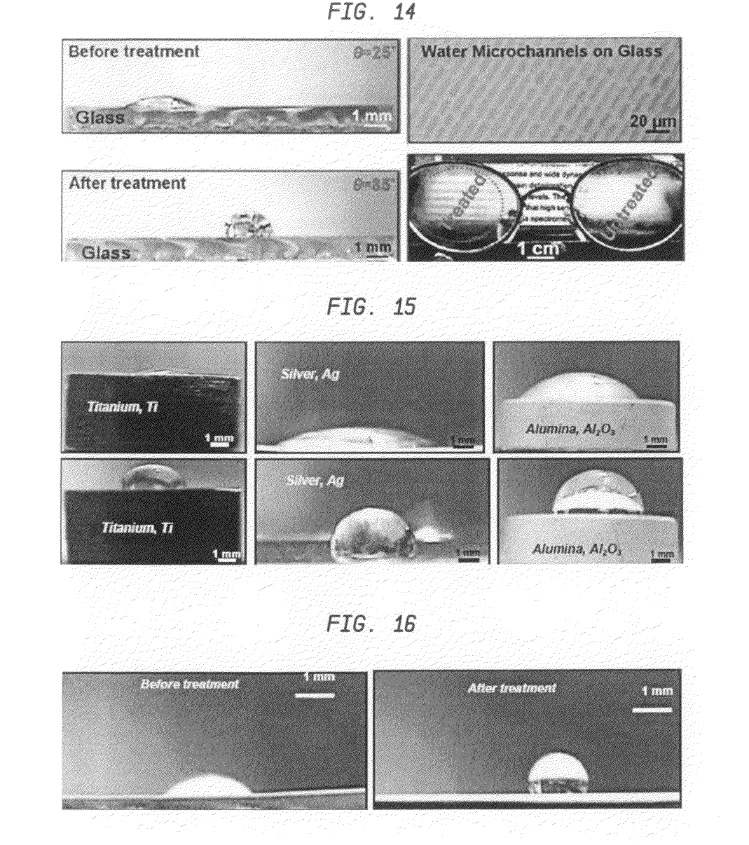

The invention also allows for modifying the wettability of such amorphous material as glass. FIG. 14 demonstrates the result of electron beam charging of glass material. Irradiating glass material with an electron beam led to a pronounced variation in wettability in a very wide range. The electron energy was Eₚ=120 eV, electron current density was Jₚ=100 nA/cm², exposition time was varied in the range of t=0-20 min, and vacuum was of 10⁻⁶ Torr.

As may be known to a person skilled in the art, ferroelectrics are polar dielectrics possessing spontaneous electrical polarization without application of electric field. The polar faces of ferroelectric crystal LiTaO₃ were treated using combination of electron beam irradiation and UV radiation allowing variation of the wettability of the crystal in the range 6°-90°. Both faces showed the same contact angles after the treatment. The electron energy was Eₚ=300 eV, electron current density was Jₚ=100 nA/cm², exposition time was varied in the range of t=0-10 min., and vacuum was 10⁻⁶ Torr.

Different types of metals and metal oxides such as Ti, Ag, Al₂O₃, etc, were also tested. All of them showed strong variation of the surface energy (wettability) after electron irradiation as shown in FIG. 15. The irradiation conditions were adopted to each material when the electron energy was varied Eₚ=10-1000 eV, electron current density Jₚ=10-300 nA/cm², exposition time was varied in the range t=0-210 min, vacuum-10⁻⁶ Torr.

The method of the invention was also applied on paper specimens, which showed strong variation of the wettability parameters after electron irradiation (FIG. 16). This application allowed the improving of paper anti-wetting properties. The electron energy was 1000-eV, electron current density 200 nA/cm², exposition time was varied in the range 0-20 min, vacuum-10⁻⁶ Torr.

Thus, the present invention provides a novel surface property (related to the surface energy) modifying method and device that can be used in patterning (printing) applications. The invention provides for imprinting of the modified surface energy and related properties (wettability, adsorption, adhesion, friction, etc.) with high resolution; for tailoring and tuning of the wettability state in a wide range of contact angles (10-120°), and for fabricating micro/nano patterned templates.

The electron-induced surface properties modification is reversible to its initial (untreated) state using, for example, electromagnetic (light and/or heat) radiation. FIG. 17A shows wettability patterning on the SiO₂ surface using electron irradiated through a specially designed Si shadow mask. The mask contained arrays of circular holes of 100 μm in diameter and period of 200 μm. FIG. 17B demonstrates wettability patterning on the SiO₂ surface performed by two-stage process. Preliminary, this process includes electron irradiation of the entire Si sample, resulting in a hydrophobic state all over the irradiated surface. The second stage followed by UV light illumination through the Si shadow mask, reversing the hydrophobic states to the initial, hydrophilic, state in the illuminated areas.

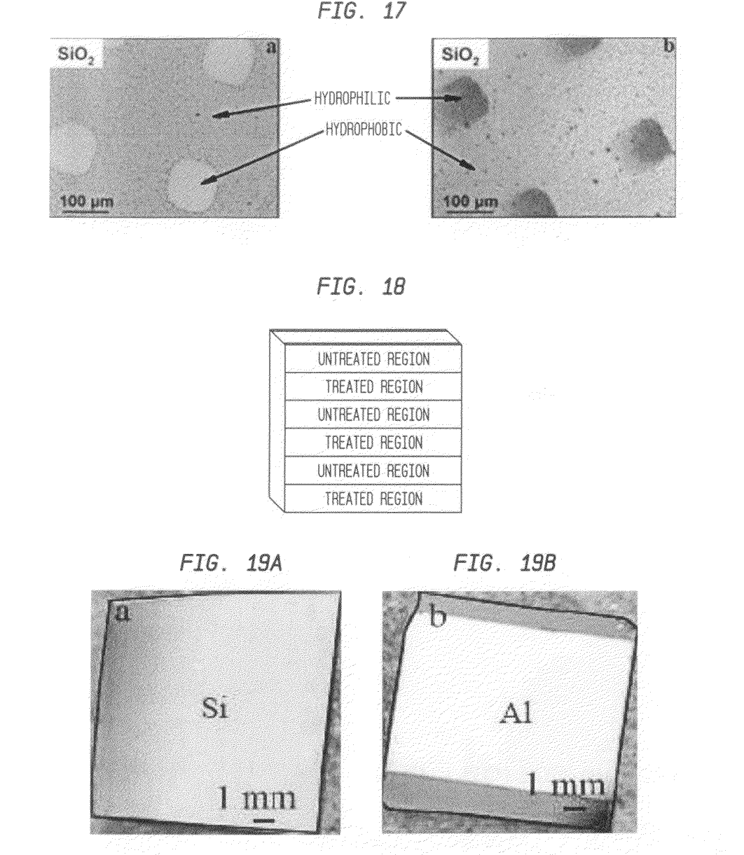

The method of the invention allows selective adhesion of different metals, such as cobalt, Co; copper, Cu; palladium, Pd; and Aluminum, Al, on a preliminary patterned as schematically shown in FIG. 18. An example of such patterning was demonstrated herein above in respect of FIG. 11.

Using vacuum Al metal sputtering on Si substrate as demonstrated in FIG. 19A, did not allow for adhesion of Al on the low surface energy (hydrophobic, θ˜90°) Si substrate induced by electron beam irradiation. On the other hand, a good adhesion of Al was observed, as shown in FIG. 19B, on untreated hydrophilic (θ˜10°) Si substrate. This result is in accordance with principles of minimization of surface energy, i.e. the surface free energy of the film should be less than or very nearly equal to that of the substrate. Such an approach allows fabrication of free standing thin films.

Those skilled in the art that various modifications and changes can be applied to the embodiments of the invention as hereinbefore described without departing from its scope defined in and by the appended claims.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for use in printing of an indicia pattern on a surface of a first solid material, the method comprising creating a surface property pattern on the surface of the first material while maintaining structural and phase state properties of the first material, said creating of the surface property pattern comprising irradiating said surface at least by an electron beam and controlling at least one parameter of said irradiation in accordance with characteristics of said first material, thereby modifying a surface property of the first material in connection with its affinity towards a certain second material in selected regions of the first material defined by the indicia pattern to be printed, thereby enabling attachment of the second material either to the selected regions or to the spaces between them on said surface of the first material, resulting in the printed indicia pattern.

2. A method according to claim 1, wherein said modifying of the surface property comprises converting the surface property from an initial hydrophilic state into a hydrophobic state.

3. A method of claim 1, wherein said irradiating comprises applying the electron beam irradiation to said selected regions, thereby directly creating said surface property pattern.

4. A method according to claim 1, wherein said applying the electron beam irradiation to said selected regions comprises scanning the surface of the first material by the electron beam.

5. A method according to claim 1, wherein said applying the electron beam irradiation to said selected regions comprises directing the electron beam irradiation onto said surface through a mask.

6. A method according to claim 1, wherein said applying the electron beam irradiation to said selected regions comprises directing a plurality of the electron beams onto said surface.

7. A method according to claim 1, wherein said irradiating comprises applying the electron beam irradiation to the entire surface or the entire portion thereof within which the indicia pattern is to be created, and then applying electromagnetic radiation to said previously irradiated surface or the portion thereof to said selected regions.

8. A method of claim 1, wherein said modification of the surface property is reversible.

9. A method of claim 2, wherein the induced variation of the surface property is reversed by applying electromagnetic radiation to the selected surface regions.

10. A method of claim 1, wherein the electron beam is a low energy beam, typically the energy substantially not exceeding 1000 eV.

11. A method according to claim 1, wherein said at least one parameter of the irradiation comprises at least one of direction of electron beam propagation, current density of electron beam, electron energy, and duration (dose) of irradiation.

12. A method according to claim 7, wherein at least one parameter of the electromagnetic radiation, selected from wavelength, intensity, polarization, duration of radiation and/or profile, is adjusted in accordance with the material being modified and its surface property to be varied.

13. A method according to claim 1 , wherein said modifying of the surface property of the material within said selected regions thereof comprises switching or gradual tuning of at least one of affinity, wettability, adhesion, adsorption, hygroscopicity, bonding, friction, encapsulation, and agglomeration.

14. A method according to claim 13, wherein said modifying of the surface property of the first material within said selected regions thereof comprises creating the affinity pattern on the surface of the first material.

15. A method according to claim 1, wherein said second material is at least one of the following: a printable ink, dye, pigment; metal; dielectric; fluorescent material; semiconductor; biomaterial; polymer, or any other material of various origin and dimension.

16. A method according to claim 1, wherein said first material has optical properties different from that of the second material.

17. A method according to claim 1, wherein said first material has electrical conductivity different from that of the second material.

18. A method according to claim 1, for creating a mask, the first and second materials having different optical properties with respect to light of a certain wavelength range.

19. A method according to claim 1, wherein said first material includes at least one of a Si-based material, a dielectric crystalline or amorphous material, a metal, an oxide, a ceramic material, and powder materials.

20. A method according to claim 19, wherein said Si-based material includes at least one of P- and N-type Si, Si₃N₄, SiO₂, Si-nanodots embedded into SiO₂ matrices, fused silica and glass.

21. A method according to claim 19, wherein said dielectric, amorphous material includes at least one of, polymers, ferroelectrics, paper and crystalline materials such as mica, and alumina.

22. A method according to claim 19, wherein said metal includes at least one of Al, Zn, Ag, Co, Pd, Cu and Ti.

23. A method according to claim 22, wherein said metal is coated by native oxides.

24. A method according to claim 1 for use in creation of the indicia pattern formed by imprinted ink material on the patterned substrate.

25. A method for use in printing ink on a surface of a first solid material to create an indicia pattern, the method comprising:
creating a surface property pattern on the surface of the first material while maintaining structural and phase state properties of the first material, said creating of the surface property pattern comprising irradiating said surface at least by an electron beam and controlling at least one parameter of said irradiation in accordance with characteristics of said first material, thereby modifying a surface property of the first material in connection with its affinity towards the ink material in selected regions of the first material defined by the indicia pattern to be printed,
providing interaction between the ink material and the patterned first material thereby causing attachment of the ink material either to the selected regions or to the spaces between them on said surface of the first material, resulting in the printed indicia pattern.

26. A patterning device for creating an indicia pattern on a surface of a first solid material, the device comprising:
an irradiation system configured and operable for irradiating selected regions of the first material defined by the pattern to be printed, the irradiation system comprising at least an electron beam source configured and operable to generate a low energy electron beam; and
a control unit for operating said irradiation system to control at least one parameter of at least said electron beam in accordance with said first material in connection with its affinity towards a certain second material to be printed on the first material, so as to cause the irradiation system operation to induce or vary a surface potential and/or surface energy of the first material while maintaining structural and phase state properties of the first material, thereby enabling attachment of the second material onto the surface of the first material within either the selected regions or spaces between them.

27. A device according to claim 26, comprising a material depositing unit operable to provide interaction between the first and second materials.

28. A device according to claim 26, wherein said irradiation system comprises an electromagnetic radiation source, the control unit being configured and operable to control at least one parameter of the electromagnetic radiation source.

29. A device according to claim 26, for use in printing ink material onto a solid substrate of the first material.

30. A solid substrate having a surface property pattern, said pattern being in the form of varying affinity of the substrate towards a certain foreign material.

31. A solid substrate according to claim 30 wherein said pattern is in the form of spaced pattern regions of a first affinity towards the foreign material spaced by regions of a second affinity towards said foreign material.

32. A solid substrate according to claim 30, wherein said pattern is in the form of the varying affinity of the substrate towards an ink material, thereby enabling direct fabrication of ink pattern on the substrate by providing interaction between the ink material and the substrate.
